(19) United States
(12) Patent Application Publication
(10) Pub. No.: US 2003/0122385 A1
(43) Pub. Date: Jul. 3, 2003

(54) Door fitting for the external operation of a door, in particular a vehicle door

(76) Inventor: Stefan Monig, Schwelm (DE)

Correspondence Address: Friedrich Kueffner, Suite 910, 317 Madison Avenue, New York, NY, 10017, US

(21) Appl. No.: 10/312,798

(22) PCT Filed: Jul. 19, 2001
(86) PCT No.: PCT/EP01/08334

(30) Foreign Application Priority Data
Aug. 3, 2000 (DE) 100 37 913.3

(51) Int. Cl. E05B 3/00

(52) U.S. Cl. 292/336.3

(57) ABSTRACT

A door fitting has the grip (15) on one side and the support (25) on the other of the opposing sides (34, 36) of the external skin (35) of a door. The support has the bearing axle (40). The arms (11, 12) of the grip are threaded through two openings (37, 38) in the outer skin (35) of the door and connected to the bearing arms (21, 22) by means of couplings (41, 51) and the fit secured by means of a screw. According to the invention, in order to be able to use the fitting with any shapes of door, the interconnection of the couplings (41, 51) between the grip and the bearing arms (11, 12; 21, 22) occurs at both ends in one and the same coupling plane, which runs essentially perpendicular to the plane (35) of the door. The one type of couplings are thrust members (41), which on gripping permit a rotation (46) of the grip (15) in the coupling plane, about a rotation axis (45), running essentially perpendicular to the coupling plane. The other couplings are pins (51) which are interconnected essentially perpendicular to the plane (35) of the door.

The invention pertains to a door fitting of the type indicated in the introductory clause of claim 1. In the case of this fitting, there is a support attached to the inside surface of the outer panel of the door. This support has two projections for the bearing axle of a handle, the bearing axle being essentially parallel to the plane of the door. The handle is on the outside surface of the door, and when at rest it lies in a plane which is essentially horizontal. It is supported on the bearing axle with the freedom to swing up and down. Two angle levers, each consisting of two lever arms which can be connected to each other in pairs, serve to connect the handle to the support. The first lever arms, which are referred to below in brief as the “handle arms”, are located at the ends of the handle. The second lever arms, which are referred to in brief below as the “bearing arms”, are premounted on the bearing axle of the support. These bearing arms, the bearing axle, and the support form a preassembled structural unit. The handle is installed from the external surface of the door, to accomplish which the two handle arms are threaded successively through two openings in the outside panel of the door and connected to the associated bearing arms on the inside of the door.

For this purpose, the two handle arms have connecting means which are complementary to connecting means on the bearing arms. The connecting means of the pair at one end are designed differently from those at the other end. Before the connection is established, a cover located next to one end of the handle is removed. The connecting means of the forward angle lever, located farther away from the cover, are connected first, and then the connecting means of the rear angle lever adjacent to the cover are connected. The engagement of the connecting means on the rear angle lever is secured by a screw.

In the known fitting of this type (DE 198 13 316 A1), the connecting means on the forward angle lever consist of a bayonet connection. The two connecting parts are inserted into each other vertically with respect to a connecting axis perpendicular to the plane of the door. This is done while the handle is at an angle to its later horizontal rest position on the door. When the connecting means located on the rear angle lever are to be connected, the lever must be moved out of this angled position into an essentially horizontal position, so that the two connecting elements can rest against each other. The screw for securing this contact position is seated on the rear arm of the handle. Although this known door fitting has proven reliable, it cannot be used in doors with certain profiles. That is, many door profiles do not allow the door handle to be turned, as described above, in a rotational plane essentially parallel to the plane of the door.

The invention is based on the task of developing a fitting of the type indicated in the introductory clause of claim 1 which can be installed conveniently and reliably and which can be used universally, that is, equally well in doors with any profile. This is accompanied according to the invention by the features cited in claim 1, to which the following special meaning attaches:

In the invention, the structural unit on the support side of the handle is installed exclusively in a plane essentially perpendicular to the door, both when the connecting means on the forward angle lever are brought into engagement and also when the connecting means on the rear angle lever are brought into engagement. The connections at the two ends of the handle are therefore accomplished in a connecting plane perpendicular to the door. For this reason, the shape of the profile above and below this connecting plane is of no importance at all. The door can curve in or out above and below the connecting plane in any way desired.

The connecting means of the forward angle lever consist preferably of two thrust elements, which lie in this connecting plane and extend in the same direction as that of the handle. These elements interlock with each other exclusively in the connecting plane. These interlocking thrust elements allow the handle to rotate in the connecting plane, namely, around a rotational axis extending perpendicular to the connecting plane. As a result of such rotation, the connecting means of the rear angle lever then arrive automatically in effective working engagement with each other. The latter consist of two plug elements, which can be plugged into each other in a plane essentially perpendicular to the door. Their engagement is then secured by a locking screw. This installation procedure is very simple, and even untrained personnel can perform it without making a mistake.

Additional measures and advantages of the invention can be derived from the subclaims, from the following description, and from the drawings. The drawings illustrate the invention on the basis of an exemplary embodiment. Although the outside panel of the door has been omitted, its position between the elements of the fitting is indicated in broken line:

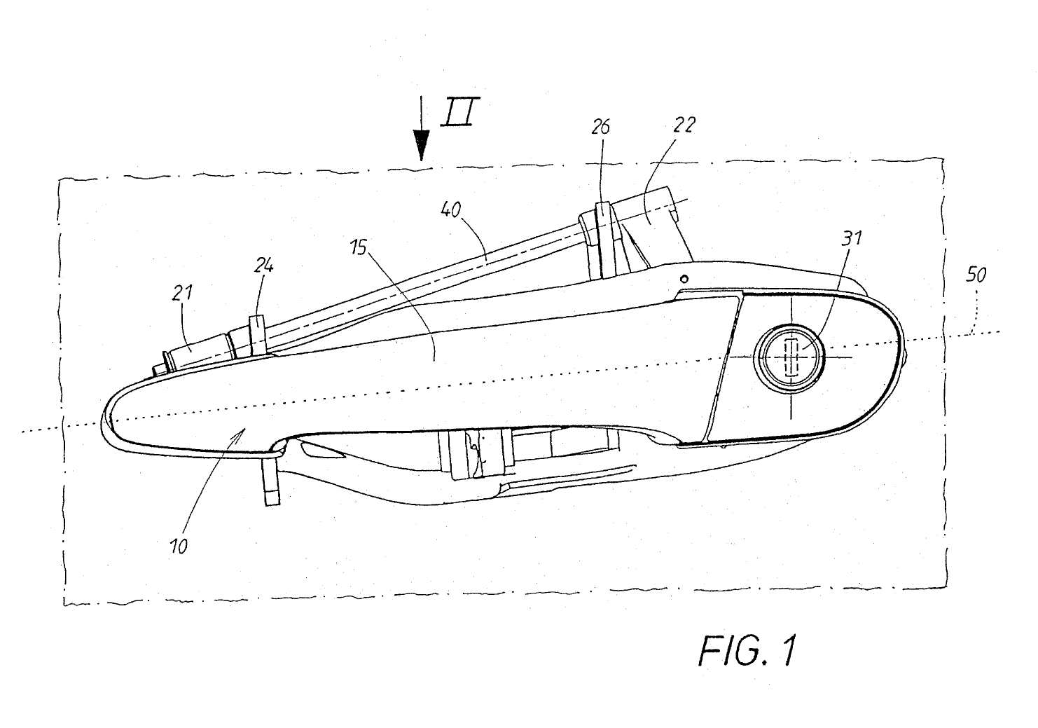

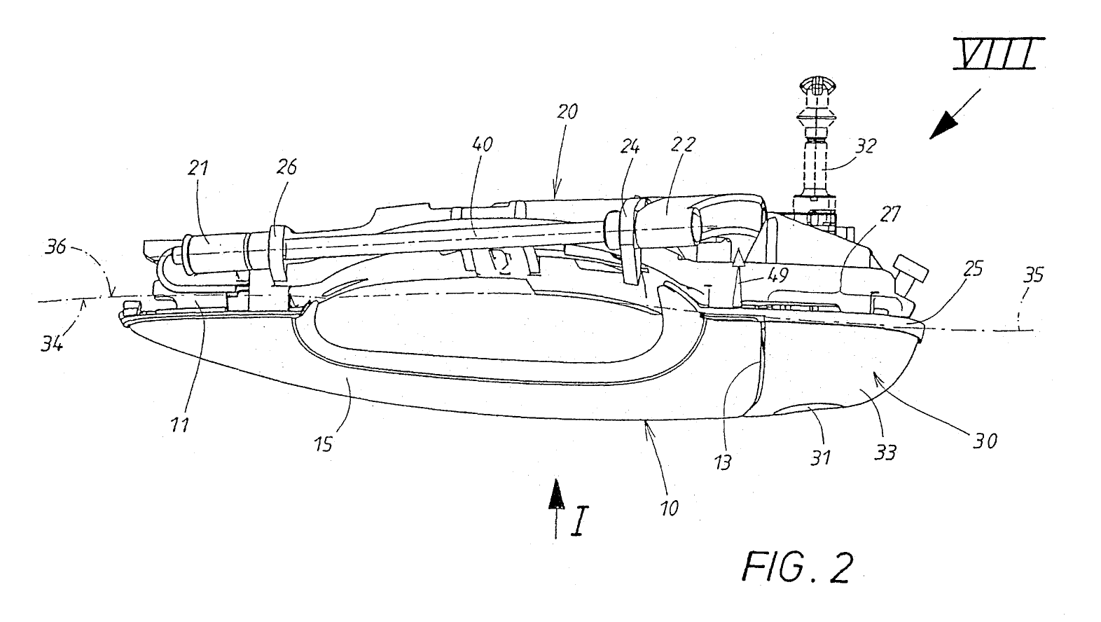

FIG. 1 shows a plan view of the completely installed door handle according to the invention in viewing direction I of FIG. 2;

FIG. 2 is a plan view, at a slight angle, of the installed fitting of FIG. 1, seen approximately in viewing direction II of FIG. 1;

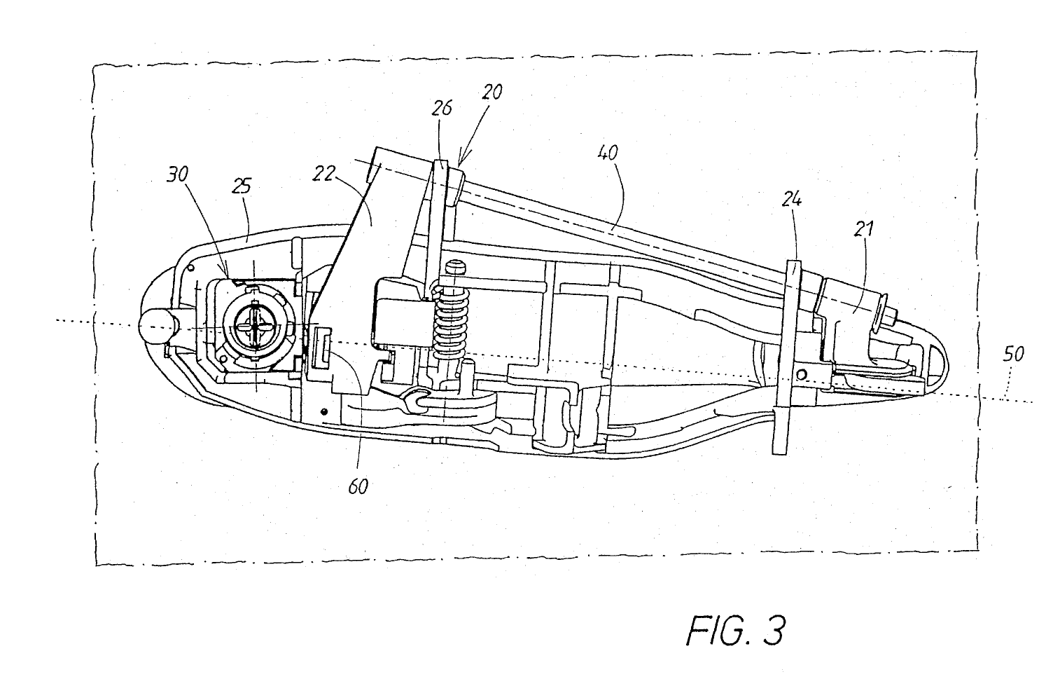

FIG. 3 is a rear view of the fitting of FIGS. 1 and 2 installed on the door;

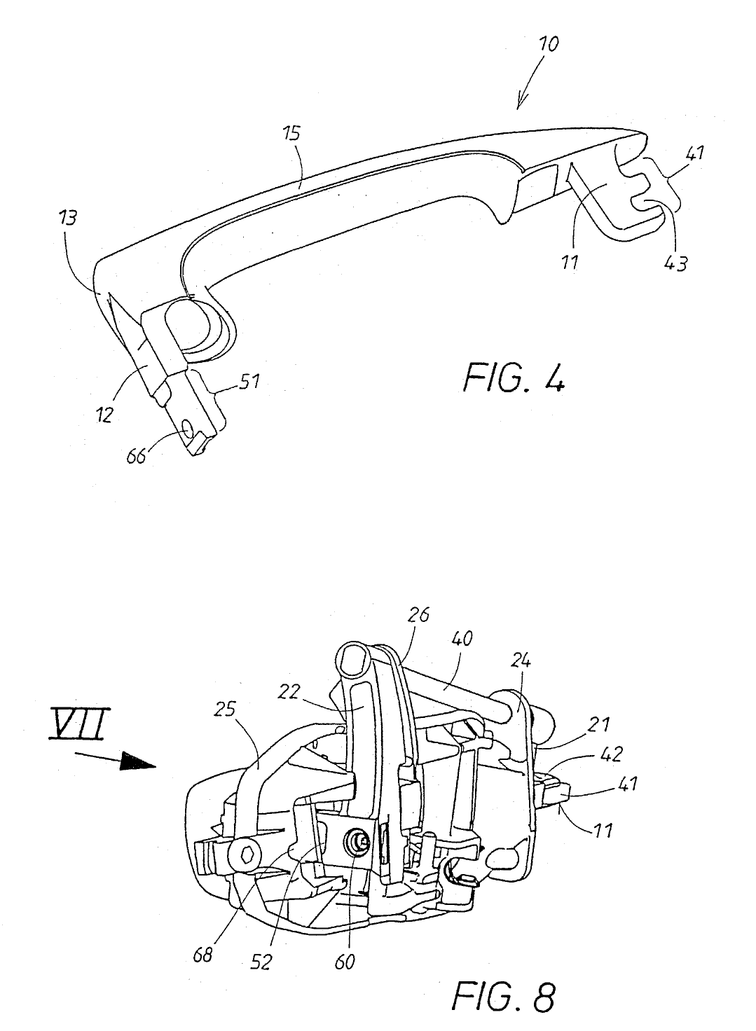

FIG. 4 shows a perspective view on one of the parts of the fitting, namely, the handle with its two arms;

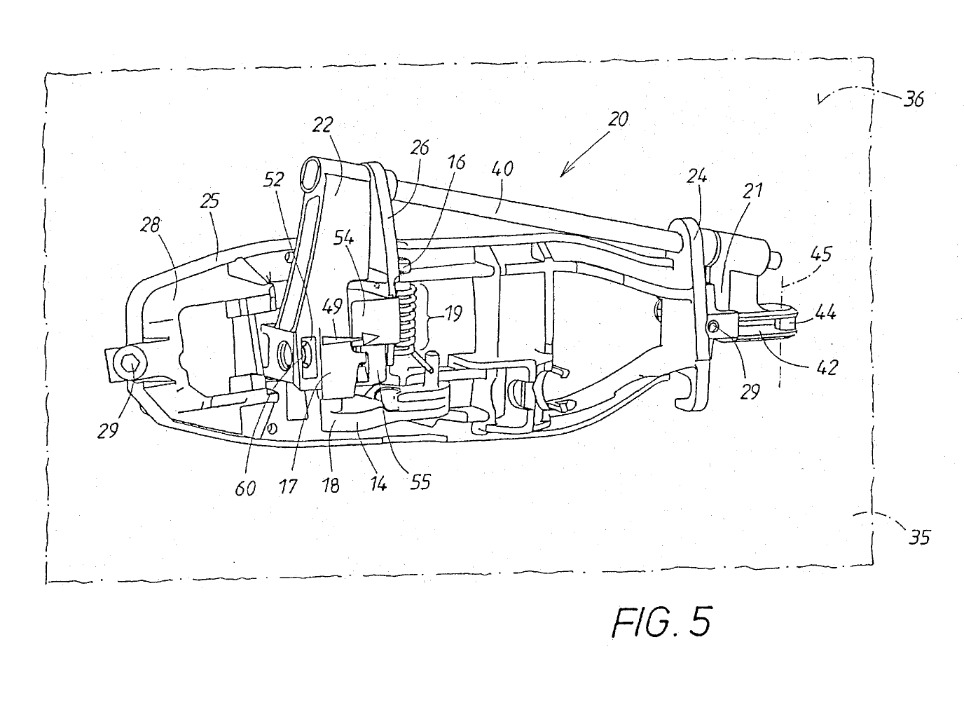

FIG. 5 shows a perspective view, similar to that of FIG. 3, of the back of the second fitting part after it has been attached to the inside surface of the outer door panel, approximately in viewing direction V of FIG. 2, although neither the handle nor the third fitting part of FIG. 2 has been installed yet;

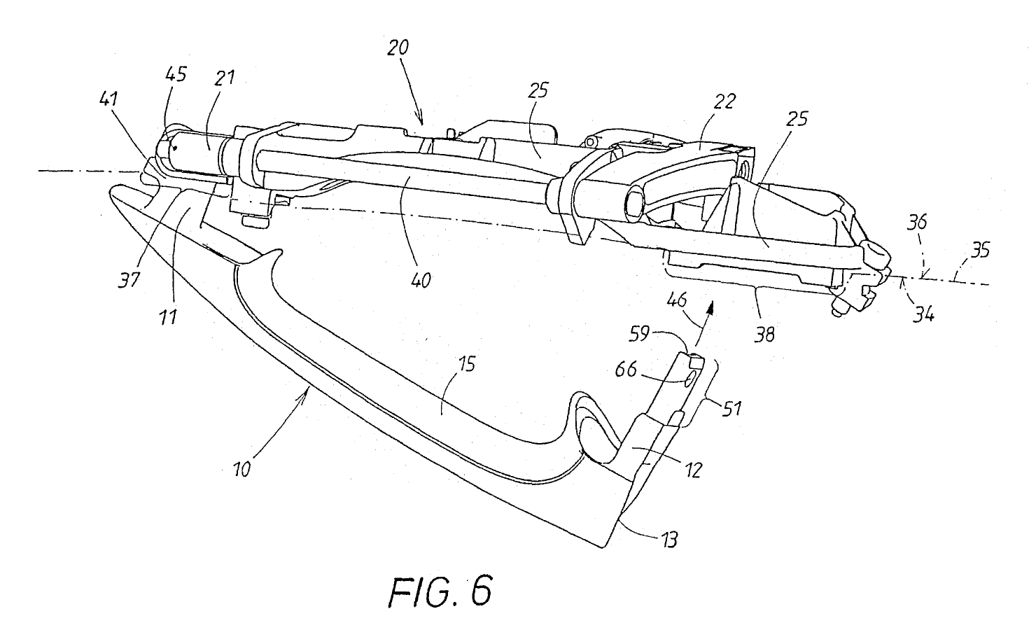

FIG. 6 shows the two fitting parts of FIG. 4 and FIG. 5 in a view corresponding approximately to the plan view of FIG. 2, where the parts have already been connected to each other at the forward end but have not yet been connected at the other end;

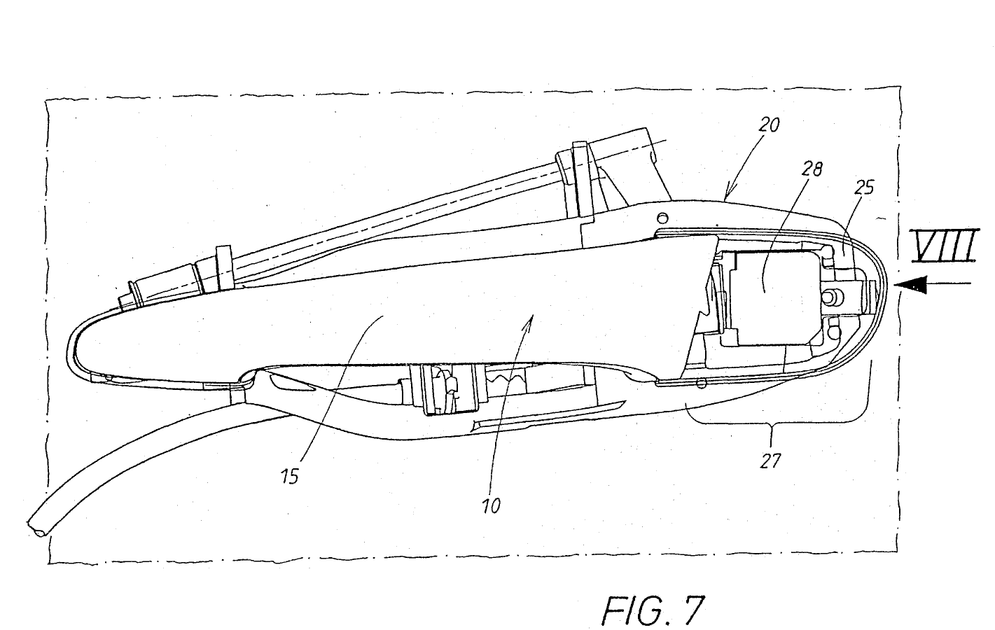

FIG. 7 shows a plan view corresponding to FIG. 1 of the completed connections at both ends of the two fitting parts of FIG. 6, the viewing direction being indicated by arrow VII in FIG. 8;

FIG. 8 shows a perspective, rear view, at a slant, of the two fitting parts of FIG. 6 after they have been connected. Although the viewing direction is indicated by arrow VIII in FIG. 2, the third fitting part, already mounted in FIG. 2, is still absent, as in FIG. 7;

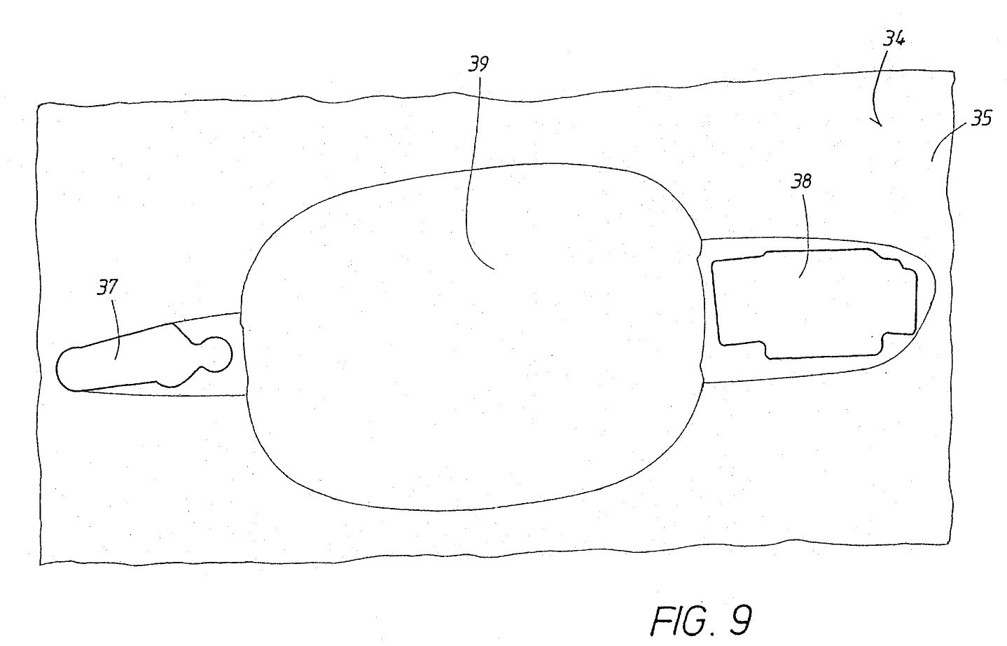

FIG. 9 shows the three-dimensional front view of a section of the outside door panel before the installation of the door fitting according to the invention; and

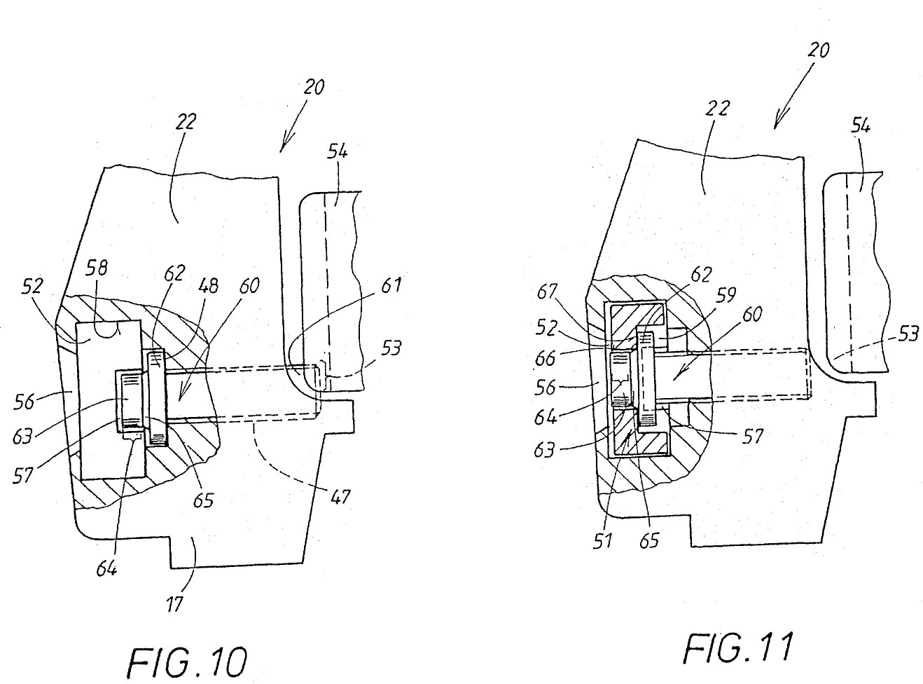

FIGS. 10 and 11 show detailed views of the two opposing positions of the locking screw which secures the engagement of the connecting means between the first and the second fitting part at the rear of the fitting, namely, in the disconnected position in FIG. 10 and in the connected position in FIG. 11.

The door fitting according to the invention consists of three fitting parts 10, 20, and 30, some of which are preassembled from several separate elements. The first fitting part 10, as can best be seen in FIG. 4, comprises a handle 15 with arms 11, 12, one on each end of the handle, these three elements being made as a single piece of plastic. This fitting part 10 with its handle 15 is installed from the outside surface 34, visible in FIG. 9, of the outside door panel 35, the two arms 11, 12 being inserted during the installation process through the openings 37, 38. So that, after all the fitting parts 10, 20, 30 have been installed as shown in FIG. 2, the handle 15 can be gripped easily by the human hand, the panel can be provided with a concavity 39, shown in FIG. 9. When they are inserted, the two arms 11, 12 of the handle fitting 10 come into contact with corresponding arms 21, 22 of the second fitting part 20, which is located on the opposite inside surface 36 of the outside door panel 35.

This second fitting part 20, as can best be seen in FIG. 5, is a structural unit, which is preassembled from several independent components. These include, first, a support 25, with a shape made up of stringers and webs adapted to the inside profile of the outside door panel. It also has projections 24, 26, which are formed out of plastic as integral parts of the support 25. At the ends, the projections 24, 26 have bearings for a bearing axle 40, which lies in the interior space of the door and is approximately parallel to the plane of door. Two arms 21, 22, which, in the installed state, work together with the previously mentioned arms 11, 12 of the handle fitting 10 in a manner to be described in greater detail below, are seated on the bearing axle 40. The various arms cooperate in pairs to form two angle arms, as can be seen FIG. 8, namely, angle arm 11, 21 in the one case and angle arm 12, 22 in the other. The support has a mounting area 27, as can best be seen in FIG. 7, for the third fitting part 30, which is initially absent during the handle assembly process and which therefore does not, at the beginning, form a component of the bearing unit 20.

This third fitting part 30 functions primarily as a cover and consists of a housing-like cover 33 part, which can be connected to other functional parts to form a single structural unit. In the exemplary embodiment shown, a lock cylinder 31 is a functional part which is integrated into the cover unit 30. The control end 32 of the lock cylinder passes through an opening in the mounting area 27 of the support 25. This opening 28 in the support lines up with the opening 38 in the panel of FIG. 9.

At first, as already mentioned, the cover unit 30 is not yet connected to the bearing unit 20. The bearing unit 20 is, as previously mentioned, attached by a fastening means 29 to the inside surface 36, shown in FIG. 5, of the outside door panel 35, indicated in broken line. According to FIG. 5, a control lever 14 on the bearing unit 20 is supported on a pivot axle 16 of the support 25. The free end 18 of the control lever 14 grips under a control surface 17 provided on the bearing arm 22. At the same time, the control lever 14 is subjected to the force of a spring 19. By way of the control means 17, 18, the bearing arm 22 is subjected to load toward the rear by the spring 19 in the direction of the force arrow 49 of FIG. 5, the resulting movement being limited by stops. The force 49 of the spring is intended to ensure that, after the handle fitting 10 has been installed as shown in FIG. 2, the fitting with its handle 15 will be held against the outside surface 34 of the outside door panel 35 or against the sealant provided there.

The installation of the handle fitting 10 on the bearing unit 20 attached to the inside surface of the outside door panel 35 is executed in successive steps involving the handle arms 11, 12 on one side and the bearing arms 21, 22 on the other. For this purpose, connecting means 41, 42 and 51, 52 are provided at each end, the engagement of which occurs in the same plane 50 as that which passes in FIG. 6 parallel to the plane of the drawing and which in FIG. 3 is illustrated by a dotted line. This plane 50 is therefore to be called the “connecting plane”. This connecting plane 50 is essentially perpendicular to the plane of the door, the course of which is determined by the outside door panel shown in dash-dot line in FIG. 6. The connecting means at the two ends, namely 41, 42 and 51, 52, however, are designed differently from each other and enter into engagement with each other in succession during the installation of the handle fitting 10, as previously mentioned.

As indicated above, the arms 11, 21 farther away from the cover unit 30 in the installed state of the door fitting form the “forward angle lever”, whereas the arms 12, 22 adjacent to the cover unit 30 are said to form the “rear angle lever”. Accordingly, the “forward arms” are said to be located at 11, 21, the “rear arms” at 21, 22. During the installation of the handle, the connecting means 41, 42 of the forward angle lever 11, 21 arrive in engagement with each other first.

The forward connecting means 41, 42 consist of thrust elements, which are complementary to each other and which are designed as described below. As can be seen in FIG. 4, the forward handle arm 11 has a plate-shaped slide 41, which is provided with a fork 43 on one side. This is the thrust element 41 which plays the active role during the connection process. The opposing connecting means 42 is located on the forward arm 21 of the bearing unit 20 and consists, as can be seen in FIG. 5, of a receptacle 42, across which a bolt 44 passes. The receptacle 42 consists of two plates, one above the other, at the free end of the bearing arm 21. During the handle installation process, which is now beginning, the arms 21, 22 of the bearing unit 20 are located advantageously in a defined preassembly position, which is between the completely down position of the handle fitting 10 according to FIGS. 1-3 (rest position of the handle 15) and the completely up position of the handle fitting 10, reached upon actuation of the handle 15. This preassembly position is defined by a screw 60, which, according to the invention, fulfills two different functions in an especially advantageous manner. That is, it holds the pivoting elements of the door fitting in the preassembly position, and it also secures the engagement between the connecting means 41, 42. The screw 60 is therefore to be called the “locking screw”. It is obvious that it would also be possible to provide separate screws for these two functions, but this would require a bulkier design.

FIG. 10 shows an enlarged, rear view of part of the bearing unit 20 shown in FIG. 5, partially cut away. The bearing arm 22 has a continuous bore 47, in which the threaded hole for the locking screw 60 is provided. In FIG. 10, this screw 60 is in its screwed-in position, where its inside end 61 projects out of the bearing arm 22 far enough to grip under a stationary shoulder 53 in the bearing unit 20. This shoulder 53 belongs to the housing 54 of a spring-loaded, pivoting finger 55, integrated into this second fitting part 20, as can be seen in FIG. 5, which goes into action automatically in the event of a crash. When a crash occurs, the finger 55 prevents the handle 15 from pivoting and therefore prevents the control lever 14 from moving in the release direction. In FIG. 10, the shoulder 53 is formed by an edge of this housing 54. The screwed-in position in FIG. 10 is defined by end stops 62, 48, which will be described in greater detail below.

When the locking screw 60 is in its screwed-in position of FIG. 10 and thus grips under the shoulder 53, the bearing arm 22 is held in this defined preassembly position by the spring force 49 acting on it. Because of the two bearing arms are connected nonrotatably to the bearing axle 40, this position of the rear bearing arm 22 is transmitted to the forward bearing arm 21 of the bearing unit 20 of FIG. 5. In the preassembly state, therefore, the two arms 22, 21 are in a defined position which is especially favorable for the process of connecting the handle fitting 10.

In this preassembly position, the receptacle 42 in the forward bearing arm 41 points in the direction of the previously mentioned connecting plane 50, which is approximately also the plane of the entire handle fitting 10. In the first phase of the installation of the handle fitting 10, the plate-shaped slide 41 of the forward handle arm 11 is inserted into the receptacle 42 in such a way that its fork 43 grips the bolt 44 in the receptacle. This connection situation can be seen FIG. 6. The bolt 44 determines a rotational axis 45, shown in dash-dot line in FIG. 5, which is essentially perpendicular to the previously mentioned connecting plane 50. The rear handle end 13 is now pivoted in the direction of the arrow 46 in FIG. 6 around this rotational axis 45. Thus the rear connecting means 51, 52 engage with each other. The position of the rotational axis 45 with respect to the handle end 13 ensures that these connecting means 51, 52 will find each other without the need for a lengthy search. These rear connecting means 51, 52 are designed in a special way.

As can be seen in FIG. 6, the rear handle arm 12 has an extension in the form of a mandrel 51. On the bearing arm 22 on the support side, a receptacle 52, visible in FIGS. 5 and 10, is located, which is open in the direction essentially perpendicular to the plane of the door. The plane of the door lies approximately in the direction in which the outside door panel 35 extends. The opposite, outside end 63 of the locking screw 60 is located in the receptacle 52 in the rear bearing arm 22, as can best be seen in FIG. 10.

On the wall of the receptacle 52 opposite the threaded hole 47 of FIG. 10, there is a hole 56 for a turning tool, which can be inserted up to a rotational actuating point on the end surface of the outside end 63 of the screw. This turning tool is used to turn the locking screw 60 and thus to adjust its position. At the outer end 62 there is a collar 62, which, in the screwed-in position of FIG. 10, enters a step-like expansion of the bore 47. The floor 48 of the expansion of 47 serves as an end stop for the end surface of the collar 62 facing it, which defines the screwed-in position of FIG. 10. A free end piece 64 and a conical transition 65 between the end piece 64 and the collar 62 remains in front of the collar 62. It is true that, in the screwed-in position of FIG. 10, the end piece 64 is in the area of the receptacle 52, but it does not project beyond a profile tab 57 provided there. This profile tab 57 defines the U-shaped opening profile 58 of the receptacle 52.

The profile of the mandrel 51 is complementary to the previously described U-shaped profile 58 of the opening in the receptacle 52. This profile of the mandrel is created by a longitudinal groove 59, the depth of which is somewhat greater than the projecting section of the screw end piece 64 in the screwed-in position of FIG. 10. Thus, according to FIG. 10, the profile 58 of the opening is free to accept the insertion of the mandrel 51 during the rotational movement 46 described in conjunction with FIG. 6. The engagement of the rear connecting means 51, 52 is now complete as well and must only be secured.

The securing of the connection is accomplished, as previously mentioned, by another actuation of the locking screw 60. Starting from the screwed-in position of FIG. 10, the screw is screwed back out by the turning tool mentioned above. This turning tool is passed through the hole 56 in the arm 22 until it meets the end surface of the outside end 63 of the screw. When the screw is backed out, the engagement between the inner end 61 of the screw and the shoulder 53 permanently attached to the housing is released first. The end piece 64 then continues to travel farther and farther into the opening 66 in the mandrel 51, as can be seen in FIGS. 4, 6, and 11. As a result, the mandrel 51 is fixed in position in the receptacle 52 in the bearing arm 22. To make it obvious how the screw 60 is to be turned in order to secure the engagement of the parts 51, 52, the screw 60 and its threaded hole 47 are provided with left-handed threads, so that the screw 60 must be turned in the clockwise direction to tighten. The screwed-out position of the locking screw 60 is also defined by stops, as shown in FIG. 11. For this purpose, the outside surface of the collar 62 of the locking screw 60 comes up against the bottom 67 of the groove 59 cut into the mandrel 51, as can be seen in FIG. 11. The engagement at 51, 52 is thus secured in both a positive and a non-positive manner.

This securing of the connecting means at 51, 52 automatically secures the engagement of the thrust elements 41, 42 provided on the two forward arms 11, 21 as well. As a result of the positive engagement in the area of the fork 43 of 41 on the one side and of the bolt 44 of 42 on the other, a disconnection of those connecting means 41, 42 is possible only in the direction of the connecting plane 50. This is prevented, however, by the engagement of the plug elements 51, 52 provided at the other end, which are fixed in their engaged position by the locking screw 60. The screwed-on position of the locking screw 60 of FIG. 11 holds together the fitting parts 10, 20 of the door fitting after they have been installed on the door.

In the recessed area of the door, a hole provides access for the turning tool, already mentioned several times, which is used to turn the locking screw 60. This access hole is aligned with the hole 56 of FIG. 10 and of FIG. 11 in the rear bearing arm 22 when these pivoting elements of the bearing unit 20 are in their previously described preassembly position with respect to the support 25. In the preassembly position, this hole lines up with a lateral opening 68 in the support 25, which can best be seen in FIG. 8. This opening 68 ensures that the turning tool is guided properly to its target as it proceeds toward its rotational engagement points on the end surface of the outer end 63 of the screw. In the screwed-out position, as FIG. 11 shows, the previously described conical part 65 passes through the opening 66 in the mandrel 51 and acts with a centering effect, which ensures that the connecting elements 51, 52 are positioned and connected properly. To make it obvious how the screw 60 is to be turned to tighten and to loosen it, it is recommended that the locking screw 60 and its threaded hole in the bore 47 be provided with left-handed threads.

### LIST OF REFERENCE NUMBERS

10 first fitting part, handle fitting

11 forward arm of 10, handle arm (FIG. 4)

12 rear arm of 10, handle arm (FIG. 4)

13 rear handle end of 15 (FIG. 4)

14 control lever (FIG. 5)

15 handle of 10

16 pivot axle of 14 at 20 (FIG. 5)

17 control surface on 22 for 18

18 free end of 14

19 spring of 14

20 second fitting part, bearing unit

21 forward arm of 20, bearing arm (FIG. 3)

22 rear arm of 20, bearing arm (FIG. 3)

24 forward projection on 25 (FIG. 5)

25 support of 20

26 rear projection on 25

27 mounting area on 25 for 30 (FIG. 7)

28 opening in 25 for 31 (FIGS. 5, 7)

29 fastening means for 20 on 35 (FIG. 5)

30 third fitting part, cover unit

31 lock cylinder

32 control end of 31

33 housing-like cover of 30

34 outside surface of 35

35 outside door panel, plane of the door

36 inside surface of 35

37 first opening in 35 for 11 (FIG. 9)

38 second opening in 35 for 12 (FIG. 9)

39 concavity in 35 (FIG. 9)

40 bearing axle in 20

41 connecting means on 11, slide (FIG. 4)

42 opposing connecting means on 21, receptacle (FIG. 5)

43 fork on 41 (FIG. 4)

44 bolt on 43 (FIG. 4)

45 rotational axis between 10 and 20 (FIGS. 5, 6)

46 arrow of rotational movement of 13 (FIG. 6)

47 threaded hole, bore in 22 for 60

48 bottom surface of expanded section of 47, end stop for 60 on 22

49 force arrow of 22 (FIG. 5)

50 connecting plane (FIG. 3)

51 connecting means on 12, plug element, mandrel

52 connecting means on 22, plug element, receptacle

53 shoulder on 54 for 61 (FIG. 10)

54 housing for 55 on 25

55 finger on 25

56 hole in 22 (FIG. 10)

57 profile tab in 52 (FIGS. 10, 11)

58 U-shaped profile of opening 52 (FIG. 10)

59 longitudinal groove in 51 (FIG. 11)

60 locking screw

61 inside end of 60

62 collar, end stop of 60 at 47

63 outside end of 60

64 end piece of 60 (FIG. 10)

65 conical transition between 62 and 64, cone (FIG. 10)

66 opening in 51

67 bottom of groove in 59 for 62 (FIG. 11)

68 opening in 25 (FIG. 8)

1. Door fitting for the external actuation of a door, especially a vehicle door,
with a handle (15) to be gripped by hand on the outside surface (34) of an outside door panel(35), which can be pivoted around a bearing axle (40) which is essentially parallel or at an angle to the direction of the handle;
with a support (25), attached to the inside surface (36) of the outside door panel (35), on which support the bearing axle (40) of the handle (15) is supported;
with two angle levers extending between the handle (15) and the support (25), which levers consist of lever arms (11, 21; 12, 22) which can be connected to each other in pairs;
where one lever arm (handle arm (11, 12)) is firmly seated on each end of the handle, while the other lever arm (bearing arm 21, 22)) is premounted on the bearing axle (40) and forms a single structural unit (20) with the support (25) and the bearing axle(40);
and possibly with a cover (33), which is attached to the support (25) next to one end (13) of the handle (15) and can contain functional parts, if desired, such as a lock cylinder (31) or a push button switch;
where, during the installation of the fitting from the outside surface (34) of the door, the two handle arms (11, 12) are threaded through two openings (37, 38) in the outside door panel(35) and connected in succession to their associated bearing arms (21, 22) on the inside of the door;
that is, where the connecting means (41, 42) of the forward angle lever (11, 21) farther away from the cover (33) are connected first and then the rear connecting means (51, 52) of the angle lever (12, 22) closer to the cover are connected;
and the engagement of the connecting means (51, 52) on the rear angle lever (12, 22) is secured by a screw (60),
characterized in that
in the case of both the forward (11, 21) and the rear angle lever (12, 22), the connecting means (41, 42; 51, 52) between the handle arm and the bearing arm interlock with each other in the same connecting plane (50), which is essentially perpendicular to the plane of the door; in that
the connecting means of the forward angle lever (11, 21) consist of two thrust elements (41, 42), which lie in this connecting plane (50) and which point in the direction in which the handle extends,
but which, in the engaged state, allow the handle (15) to rotate (46) in the connecting plane (50) around rotational axis (45) essentially perpendicular to the connecting plane (50); and in that
the connecting means of the other, rear angle lever (12, 22) are formed by two plug elements (51, 52), which can be inserted into each other in the direction essentially perpendicular to the plane of the door, the engagement of which is secured by the screw (60).

2. Fitting according to claim 1, characterized in that the screw (locking screw 60) serving to secure the engaged position of the plug-in elements (51, 52) can be screwed into the bearing arm (22) of the rear angle lever.

3. Fitting according to claim 1 or claim 2, characterized in that, in the structural unit (20) on the support side, the bearing arms (21, 22) mounted on the bearing axle (40) are spring-loaded (49) to pivot the handle (15) toward the outside door panel (35).

4. Fitting according to one of claims 1-3, characterized in that the thrust element seated on the forward handle arm (11) is a plate-shaped slide (41) with a lateral fork (43),
whereas the complementary element on the support-side bearing arm (21) is a receptacle (42), pointing essentially in the longitudinal direction of the handle (15), which receptacle is terminated by a bolt (44) passing transversely across the receptacle; and in that
after the parts have been inserted into each other, the base of the fork on the slide (41) grips the bolt (44) in the receptacle (42) and thus creates a rotary bearing (45) for the controlled insertion (46) of the plug elements of the rear handle arm (22) and the door-side bearing arm (12) into each other.

5. Fitting according to one of claims 1-4, characterized in that the plug element seated on the rear handle arm (12) is a shaped mandrel (51),
whereas the opposing plug element on the support-side bearing arm (22) is a receptacle (52), which is open in the direction essentially perpendicular to the plane of the door; and in that
the locking screw (60) can be screwed in the bearing arm (22) and engages in the receptacle (52) to perform its locking function.
